(19) United States
(12) Patent Application Publication
(10) Pub. No.: US 2009/0047896 A1
(43) Pub. Date: Feb. 19, 2009

(54) Ventilation device for enabling a gas transfer via a wall of a housing

(76) Inventor: Thomas Wolff, Unterschleissheim (DE)

Correspondence Address: COLLARD & ROE, P.C., 1077 NORTHERN BOULEVARD, ROSLYN, NY, 11576, US

(21) Appl. No.: 11/665,664

(22) PCT Filed: Sep. 28, 2005
(86) PCT No.: PCT/EP05/54871

§ 371 Date: Apr. 18, 2007

(30) Foreign Application Priority Data
Oct. 28, 2004 (DE) 10 2004 052 361.4

(51) Int. Cl. F24F 13/20; B23P 17/04

(52) U.S. Cl. 454/367; 29/592

(57) ABSTRACT

The invention relates to a covering placed against the housing wall by means of a self-adhesive coating applied to the underside of the covering and covers the recess provided in the housing wall. An inner opening passing through to the inside of the housing is provided in the recess. A gas-permeable, however fluid-impermeable, diaphragm is glued over the inner opening. The adhesive coating applied to the underside of the covering is discontinuous in the area of the inner opening in order not to close the pores of the diaphragm. The outer opening is situated so that it is laterally offset from the inner opening, and is made in the covering while being completely delimited thereby.

The present invention relates to a ventilation device for enabling a gas transfer via a wall of a housing, in particular a ventilation device for enabling a gas transfer via a wall of a housing having a recess situated in the wall, an inner opening, which connects the recess to the interior of the housing, and a covering, which partially covers the recess toward the exterior of the housing, so that at least one outer opening, which connects the recess to the exterior of the housing and is offset to the vertical projection of the inner opening on the covering without overlap, remains exposed.

Electrical and electronic devices are frequently used in dusty, damp, or corrosive environments, for example, in automobile construction or in processing apparatus and machines. In addition, they may also sometimes be subjected to mechanical strains, such as shock or impact strains. In order to ensure the function of the electrical and/or electronic components contained therein, the devices are therefore installed in closed housings. The latter must be sealed against the cited harmful influences, but nonetheless it is typically necessary to provide pressure equalization openings which permit a gas transfer with the environment. In particular, in the event of falling ambient temperature, it must be ensured that water molecules from the air contained in the housing interior may diffuse outward to avoid harmful condensation in the device. Keeping the air in the housing interior so dry that no condensation occurs at all foreseeable ambient temperatures typically fails because a completely hermetic housing seal would be unreasonably costly, as would dehumidifying the ambient air when equipping the housing before closing the housing, or because the housing must be opened multiple times during its usage cycle. The latter is the case, for example, in a lamp housing which has an operating life multiple times higher than the lamp used therein.

To nonetheless avoid the penetration of liquid water and dust, gas transfer openings used for pressure equalization and/or vapor pressure equalization have sometimes been closed by gas-permeable diaphragms. Corresponding diaphragms may also be provided as self-adhesive labels or parts thereof to allow simple application. A label of this type is known, for example, from German Published Application DE 196 53 890 A1.

However, it is frequently inadequate to solely cover a gas transfer opening with a diaphragm, because typical diaphragms only offer limited protection against the passage of liquids. Thus, for example, water passes through most commercially available diaphragms if the jet of a high-pressure cleaner is directed thereon. This is not unusual in practice, for example, for control units of building machinery or electronic devices in processing technology.

Furthermore, exposed diaphragms may become leaky or may even be completely destroyed by mechanical damage.

Situating a gas transfer opening, which is glued over by a diaphragm, in a recess of a housing wall and gluing over the recess using a protective covering, which may simultaneously also function as a nameplate, is known from WO 99/29150 A1. The gas transfer remains ensured by providing channel-like depressions (ventilation channels) in the housing wall starting from the recess, which are only partially covered by the covering, through which a ventilation device of the type cited at the beginning results. However, a configuration of this type is quite complex to produce, because the relatively complexly shaped depressions must be produced in the housing wall by correspondingly complex shaping and/or processing processes. Furthermore, a moderate lateral offset of the covering in relation to its intended position caused by erroneous attachment may result in the ventilation channels being completely covered, and the ventilation device no longer functioning. Furthermore, the covering must be manufactured specifically for the geometry to be covered in order to ensure its function.

In view of the problems described above, the present invention is based on the object of providing a ventilation device of the type cited at the beginning which is producible easily and at low cost, and has greater functional reliability. Furthermore, it is the object of the present invention to provide a method for producing ventilation devices in housing walls of various housing batches, which also permits rapid and even unforeseen batch changes.

According to one aspect of the present invention, the object on which it is based is achieved by a ventilation device according to Claim 1.

Advantageous embodiments of the ventilation device according to the present invention may be implemented according to one of Claims 2 through 14.

The costly manufacturing of complex channel structures in the housing wall is no longer necessary according to the present invention. Rather, simple geometries of the recess (circular, oval, polygonal, etc.) may also be implemented without impairing the functional capability. The attachment of the covering permits greater tolerances in regard to lateral displacements than in the prior art.

While in many cases it may be sufficient not to cover the inner opening with its own gas-permeable diaphragm, this measure is usually indicated for avoiding the penetration of foreign materials. Manifold diaphragms which are known per se, made of expanded PTFE, for example, come into consideration for a corresponding coverage of the inner opening. Furthermore, microfiber fabric and the like may also be used. The diaphragm may be glued on or also attached in another way.

The covering of the recess may comprise greatly varying materials, however, single-layer or multilayer films are especially preferred. In particular, typical plastic films may be used here, for example, made of PET, PE, PP, PVC, etc. Depending on the mechanical strain to be expected, fabric layers or nonwoven materials may also be integrated in the film. Gas-permeable fabric layers or nonwoven materials may also be implemented continuously (i.e., covering the outer opening) in the area of the outer opening(s) and prevent the penetration of foreign bodies, such as grains of sand, into the recess. Furthermore, the outer openings may also be covered by a gas-permeable diaphragm integrated into the film structure, to offer two-stage protection against the penetration of liquids into the housing interior. In regard to the protection against penetrating foreign bodies, it may also be especially advantageous to provide multiple smaller outer openings instead of one or fewer larger outer openings. The possibility of increasing the protection of the housing interior against the penetration of foreign materials in this way is not possible in typical ventilation devices of the type cited at the beginning.

Depending on the area of application, it may also be advantageous to produce the covering from other materials, for example, thin sheet metal.

In addition to the especially preferred application by gluing, the covering may also be advantageously attached in another way depending on the material pair of housing/covering and depending on the area of application, for example, by vulcanizing, welding, soldering, screwing, or clamping. Gluing may be implemented especially well if the covering is coated on the bottom with adhesive before the attachment. Both adhesive coating over the entire area and also adhesive coating only in the boundary areas of the covering are possible here. In principle, a large bandwidth of typical adhesives is suitable, which are to be selected from as a function of the concrete application. In addition to typical pressure-sensitive adhesives, heat-activatable adhesives (hot melt) and adhesives which cure using UV light or exposure to moisture may be advantageous.

If multiple outer openings are provided in the covering, these may be positioned in such a way that after liquid enters the recess, it may flow back out in the event of different spatial orientation of the housing. For this purpose, the outer openings are to be situated in different directions (viewed from the vertical projection of the inner opening onto the covering), laterally offset to the inner opening.

If the vertical projection of the boundary line of the recess onto the covering intersects or contacts the boundary line of at least one of the outer openings, liquid may flow out of the recess especially well. If the vertical projection of the boundary line of the recess onto the covering does not contact or intersect the boundary line of at least one of the outer openings, the covering thus typically does not have to be positioned so precisely when it is attached.

Openings may also be provided in the covering, which lie outside the vertical projection of the boundary line of the recess onto the covering, i.e., lie directly on the housing wall. Openings of this type do not fulfill any function, but standard coverings which are usable in manifold ways may thus be used, which also fulfill their function in the event of another configuration of the recess to be covered. Therefore, a reduction in cost is possible due to higher piece counts in the production of the coverings.

According to a further aspect of the present invention, the object on which it is based is achieved by a method according to Claim 15.

Advantageous embodiments of the method according to the present invention may be implemented according to one of Claims 16 through 22.

The present invention offers the possibility of using standardized flat material for the coverings, which is then provided with outer openings in a batch-specific way, preferably “in-line”. Ventilation devices according to the present invention are thus possible flexibly and at lower material and storage costs, even in the event of a larger number of differently designed housing types having frequent and/or unforeseen batch changes.

In principle, any variation of the present invention described and/or indicated in the scope of the present application may be especially advantageous, depending on the economic and technical conditions in the specific case. Individual features of the embodiments described are exchangeable or combinable with one another if not specified otherwise and/or if technically implementable in principle.

In the following, examples of preferred embodiments of the present invention are explained in greater detail on the basis of the associated drawing. The figures of the drawing are purely schematic and are not to scale. Elements corresponding to one another are each provided in the individual figures with the same reference signs if expedient.

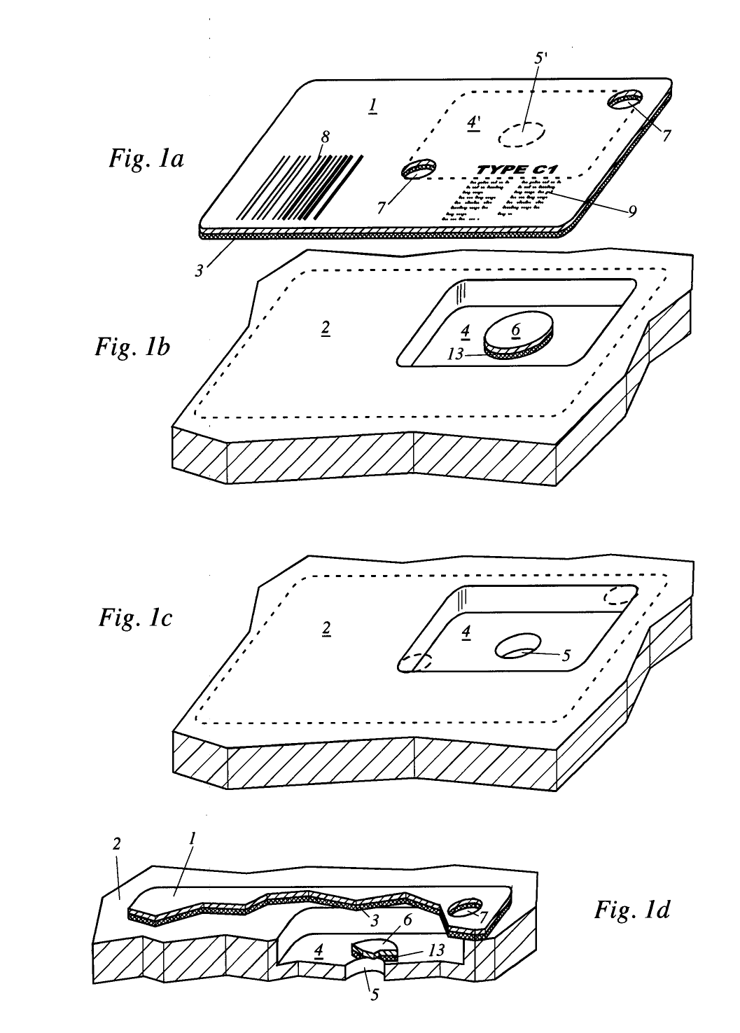

FIG. 1a shows a perspective diagonal view of the covering, also functioning as a nameplate, of a ventilation device according to the present invention having two outer openings. The boundary of the recess and the vertical projection of the inner opening onto the covering are indicated by dashed lines.

FIG. 1b shows a perspective diagonal view of a detail of a housing wall having a recess belonging to the same ventilation device as FIG. 1a, in which the inner opening is covered by a glued-on diaphragm. The position of the associated covering from FIG. 1a is indicated by dashed lines.

FIG. 1c shows a perspective diagonal view of the detail of the housing wall from FIG. 1b, but without the diaphragm. The positions of the covering from FIG. 1a and the outer openings are indicated by dashed lines.

FIG. 1d shows a perspective diagonal view of a section through the housing wall from FIG. 1b having a covering from FIG. 1a attached thereto, covering, diaphragm, and housing wall each being sectioned along different sectional lines.

FIG. 1e shows a covering from FIG. 1a in a top view, the boundary of the recess and the vertical projection of the inner opening onto the covering being indicated by dashed lines.

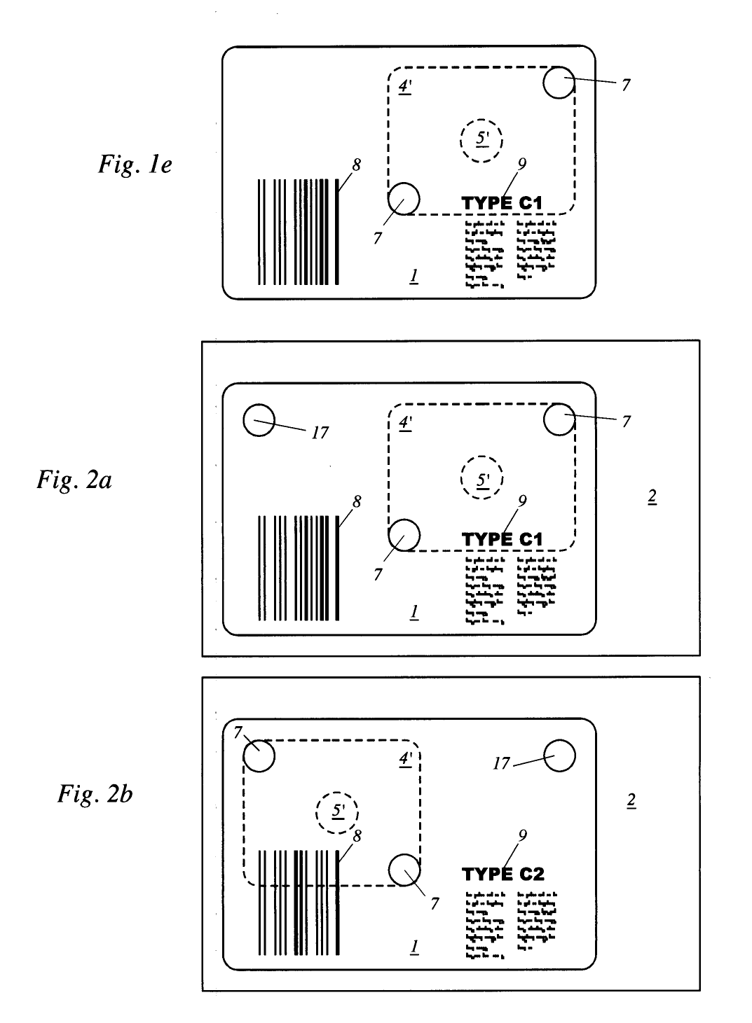

FIG. 2a shows a top view of a ventilation device having a covering designed similarly to FIG. 1e over a recess (indicated by dashed lines) having an inner opening, the housing outlines being indicated as rectangular.

FIG. 2b shows a ventilation device, in which, in contrast FIG. 2a, the recess (indicated by dashed lines) having an inner opening is located in another position in relation to the attachment location of the covering.

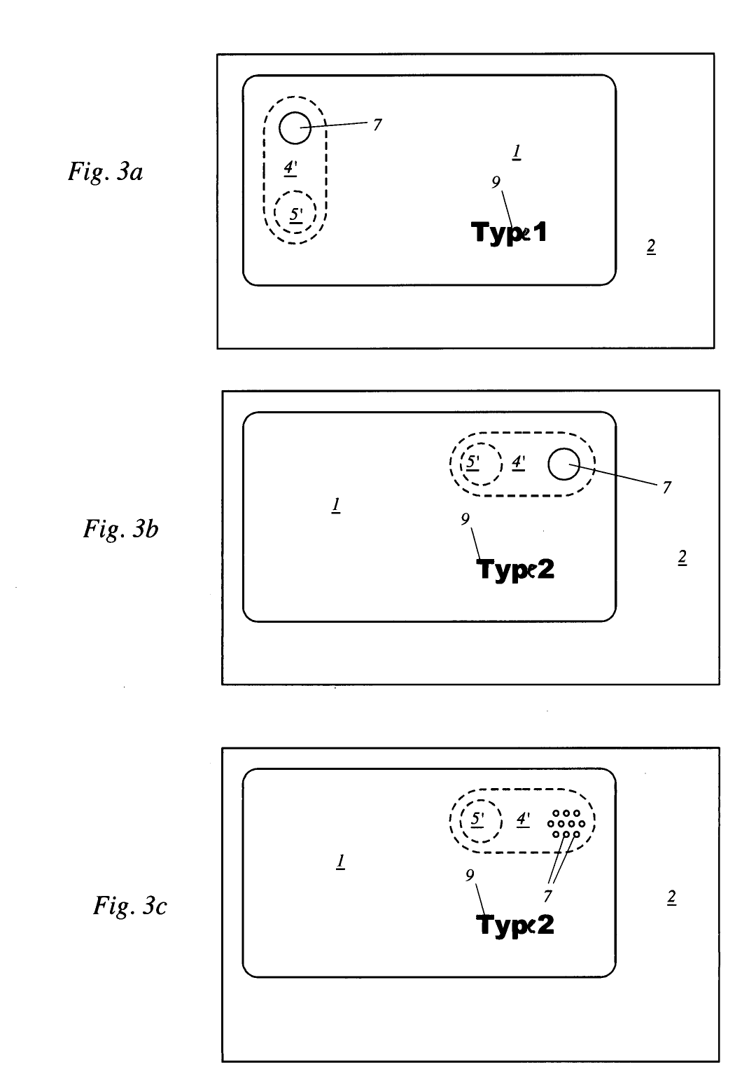

FIG. 3a shows a top view of a further ventilation device having recess and inner opening indicated by dashed lines.

FIG. 3b shows a ventilation device designed similarly to FIG. 3a having a covering, which is manufactured from an identical blank as the covering in FIG. 3a, the outer opening being situated at a different point than in FIG. 3a because of different positioning of recess and inner opening (indicated by dashed lines).

FIG. 3c shows a ventilation device designed similarly to FIG. 3a, in contrast to FIG. 3b, multiple smaller outer openings being provided instead of one larger outer opening.

FIGS. 1a-e illustrate the same embodiment. The covering 1 is attached via a self-adhesive coating 3 on the bottom to the housing wall 2 and covers the recess 4 provided therein. An inner opening 5 passing through to the housing interior is provided in the recess 4. The vertical projections of the recess 4 and the inner opening 5 onto the covering 3 are identified in the following by the reference signs 4′ and 5′, respectively. The bottom adhesive coating 13 is interrupted in the area of the inner opening 5 so the pores of the diaphragm 6 are not closed.

The two outer openings 7 are situated laterally offset to the projection 5′ of the inner opening 5 and in different directions therefrom. The configuration of the outer openings 7 in two diametrically opposite “corners” of the recess 4, which approximates a rectangle, is especially favorable in regard to the drainage of liquid from the recess 4. If one imagines three axes of rotation perpendicular to one another, around which the housing wall 2 is rotatable, a rotational range of 180° results for each of the axes, within which liquid may drain from the recess 4 through one of the outer openings 7. This means that in a fourth of all possible orientations which the housing wall 2 may assume in space, liquid may also drain under the effect of gravity from the recess 4 if it has entered it. Liquid may drain out of the recess 4 under the effect of gravity in half of all possible orientations which the housing wall 2 may assume in space through further outer openings 7 in the remaining two corners. The drainage behavior may be improved further if the walls of the recess 4 are shaped diagonally, so that the recess 4 expands outward, and/or if the recess 4 is implemented in a trough shape.

The configuration of the outer openings 7 in the covering shown in FIGS. 1a-e also results in at least one outer opening 7 remaining exposed even if the covering 1 is unintentionally attached having a strong lateral offset during the production of the ventilation device.

A configuration of the covering openings 7 in which the boundary of the covering openings 7 neither contacts nor intersects the boundary of the vertical projection 4′ of the recess 4 onto the covering 1 is also possible according to the present invention (as described below in connection with FIGS. 3a-c).

The covering 1 is also able to function as a nameplate by printing or later inscription with a barcode 8 and an alphanumeric imprint 9. Of course, a design as a warning or instruction plate, a decorative screen, or a similar object is also possible.

As may be recognized easily by comparison with FIG. 1e, the ventilation devices in FIGS. 2a-b are designed similarly. However, the covering 1 has a further opening 17 in each case, which lies outside the recess 4 (recognizable by its vertical projection 4′ onto the covering 1) and thus rests directly on the housing wall 2. This opening 17 has no function in use, but identically designed coverings for the variations shown in FIG. 2a and FIG. 2b may be used in this way, although the recess 4 and inner opening 5 (recognizable by their vertical projections 4′ and 5′, respectively, onto the covering 1) are situated differently in both variations. This allows an identical part strategy in manufacturing, which reduces the cost of production of the two different housing types.

FIGS. 3a-c also show housing walls 2, in which the recess 4 and inner opening 5 (recognizable by their vertical projections 4′ and 5′, respectively, on the covering 1) are situated at two different positions. According to the present invention, an identically designed blank may be used in each case for the particular covering 1. The batch-specific or housing-specific inscription 9 and the outer opening 7 or outer openings 7 are produced shortly before (or possibly also shortly after) attachment of the covering 1, preferably “in-line”, appropriate to the particular housing type. Standard tools or a laser may be used for introducing the outer openings 5. Variations of covering blanks which are already pre-weakened at various points to generate outer openings at the weak points as needed are also possible.

In the variation illustrated in FIG. 3c, in contrast to the variation illustrated in FIG. 3b, multiple smaller outer openings 7 are provided instead of one larger outer opening 7. This embodiment makes it more difficult for foreign bodies, such as grains of sand, to penetrate into the recess 4.

According to the present invention, multiple recesses 4 each having inner openings 5 may also be covered by a joint covering 1 if needed.

1-21. (canceled)

22. A ventilation device for enabling a gas transfer through a wall of a housing, having
a recess situated in the wall,
an inner opening, which connects the recess to the interior of the housing,
a covering, which partially covers the recess toward the exterior of the housing, so that at least one outer opening, which is offset to the vertical projection of the inner opening onto the covering so there is no overlap and which connects the recess to the exterior of the housing, remains exposed,
wherein the outer opening is implemented in the covering and is completely bounded by it.

23. The ventilation device according to claim 22, wherein a gas-permeable diaphragm which closes the inner opening is situated below the covering.

24. The ventilation device according to claim 23, wherein the diaphragm is at least partially hydrophobic.

25. The ventilation device according to claim 23, wherein the diaphragm is at least partially hydrophobized.

26. The ventilation device according to claim 23, wherein the diaphragm is at least partially oliophobic.

27. The ventilation device according to claim 23, wherein the diaphragm is at least partially oliophobized.

28. The ventilation device according to claim 22, wherein at least two outer openings are implemented in the covering.

29. The ventilation device according to claim 28, wherein at least two of the outer openings are offset in different directions to the vertical projection of the inner opening onto the covering.

30. The ventilation device according to claim 29, wherein the connection lines between the center points of two of the outer openings and the center point of the vertical projection of the inner opening onto the covering enclose an angle of at least 90°.

31. The ventilation device according to claim 22, wherein the vertical projection of the boundary line of the recess onto the covering intersects or contacts the boundary line of at least one of the outer openings.

32. The ventilation device according to claim 22, wherein the vertical projection of the boundary line of the recess onto the covering neither intersects nor contacts the boundary line of at least one of the outer openings.

33. The ventilation device according to claim 22, wherein openings, which lie outside the vertical projection of the boundary line of the recess onto the covering, are provided in the covering.

34. The ventilation device according to claim 22, wherein the covering is glued onto the wall.

35. The ventilation device according to claim 22, wherein the covering is provided with information including at least one of text and image and code information.

36. The ventilation device according to claim 35, wherein at least a part of the information is printed on.

37. The ventilation device according to claim 35, wherein at least a part of the information is generated by a laser inscription method.

38. A method for producing ventilation devices for enabling a gas transfer through walls of housings, wherein
multiple batches of housings are provided, having a wall having a recess configuration, which is uniform for each batch and differs from batch to batch, having at least one recess and at least one inner opening, which connects the recess to the interior of the housing,
a number of coverings, which at least corresponds to the number of housings, of identical dimensions, which exceed the dimensions of the largest recess, are provided,
the recess configuration of each housing is covered by attaching a covering at a uniform position of the particular housing for each batch, and
the coverings are provided, at positions of the particular covering which are uniform for each batch of housings and differ from batch to batch, with at least one hole, which is offset without overlap to the vertical projection of the inner opening of the covered recess configuration onto the covering after attachment of the covering.

39. The method according to claim 38, the coverings being provided with the at least one hole by laser action.

40. The method according to claim 38, wherein the coverings are provided with the at least one hole by punching.

41. The method according to claim 38, wherein the coverings are attached by gluing.

42. The method according to claim 38, wherein the coverings are provided with information including at least one of text and image and code information which differs from batch to batch.

43. The method according to claim 42, wherein at least a part of the information is printed on.

44. The method according to claim 42, wherein at least a part of the information is generated by a laser inscription process.
